(19) United States
(12) Patent Application Publication
(10) Pub. No.: US 2019/0300332 A1
(43) Pub. Date: Oct. 3, 2019

(54) MONITORING SYSTEM

(71) Applicant: Mitsubishi Electric Corporation, Tokyo (JP)

(72) Inventor: Kazuaki Koide, Tokyo (JP)

(73) Assignee: Mitsubishi Electric Corporation, Tokyo (JP)

(21) Appl. No.: 16/303,148

(22) PCT Filed: Sep. 14, 2016
(86) PCT No.: PCT/JP2016/077158

§ 371 Date: Nov. 20, 2018

(51) Int. Cl. B66B 1/34; B66B 5/00

(52) U.S. Cl. CPC B66B 1/3446; B66B 5/0018

(57) ABSTRACT

The monitoring system (1) includes an elevator control panel (2), a monitoring device (5), an elevator control panel (3), and a monitoring device (6). The monitoring device (5) includes a communication circuit (14), a control circuit (13), and a power supply circuit (12). The monitoring device (6) includes a control circuit (26) and a power supply circuit (25). The power supply circuit (12) supplies power from the elevator control panel (2) to the control circuit (13). The control circuit (13) supplies power to the communication circuit (14). The control circuit (13) and the control circuit (26) are connected via a communication wire (32) so that information can be transmitted to the control circuit (13).

### FIELD

This invention relates to a monitoring system capable of communicating with a monitoring center.

### BACKGROUND

PTL 1 describes a monitoring system including a plurality of elevator devices. The monitoring system described in PTL 1 includes a communication device for communicating with a monitoring center. In this monitoring system, information relating to each elevator device is transmitted to the monitoring center via the communication device.

### CITATION LIST

### Patent Literature

### [PTL 1] JP 2007-1712 A

### SUMMARY

### Technical Problem

In conventional monitoring systems, it is necessary to provide a power supply for a communication device, separately from a power supply for an elevator device, that is, an elevator control panel.

This invention is made in order to solve the aforementioned problem. An object of this invention is to provide a monitoring system having no need to provide a power supply necessary only for a circuit for communication.

### Solution to Problem

A monitoring system of the present invention comprises a first elevator control panel, a first monitoring device capable of communicating with the first elevator control panel, a second elevator control panel, and a second monitoring device capable of communicating with the second elevator control panel. The first monitoring device includes a first communication circuit that communicates with a monitoring center, a first control circuit that controls the first communication circuit and supplies power to the first communication circuit, and a first power supply circuit that supplies power from the first elevator control panel to the first control circuit. The second monitoring device includes a second control circuit, and a second power supply circuit that supplies power from the second elevator control panel to the second control circuit. The first control circuit and the second control circuit are connected via a communication wire so that information can be transmitted to the first control circuit. If power supply from the first power supply circuit to the first control circuit fails, power from the second elevator control panel is supplied from the second power supply circuit to the first control circuit.

### Advantageous Effects of Invention

In a monitoring system according to this invention, power is supplied from a first elevator control panel to a first communication circuit. The monitoring system according to this invention eliminates the need to provide a power supply necessary only for a circuit for communication.

### BRIEF DESCRIPTION OF DRAWINGS

FIG. 1 is a diagram illustrating an example of a monitoring system according to Embodiment 1 of this invention.

FIG. 2 is a diagram illustrating an example of the monitoring system according to Embodiment 2 of this invention.

FIG. 3 is a diagram illustrating an example of the monitoring system according to Embodiment 3 of this invention.

FIG. 4 is a flowchart illustrating a procedure for replacing a monitoring device.

FIG. 5 is a diagram for describing the procedure for replacing the monitoring device.

FIG. 6 is a diagram for describing the procedure for replacing the monitoring device.

FIG. 7 is a diagram illustrating an example of the monitoring system according to Embodiment 5 of this invention.

### DESCRIPTION OF EMBODIMENTS

The present invention will be described with reference to the accompanying drawings. Redundant descriptions will be simplified or omitted as appropriate. In each of the drawings, the same reference signs indicate the same or corresponding parts.

### Embodiment 1

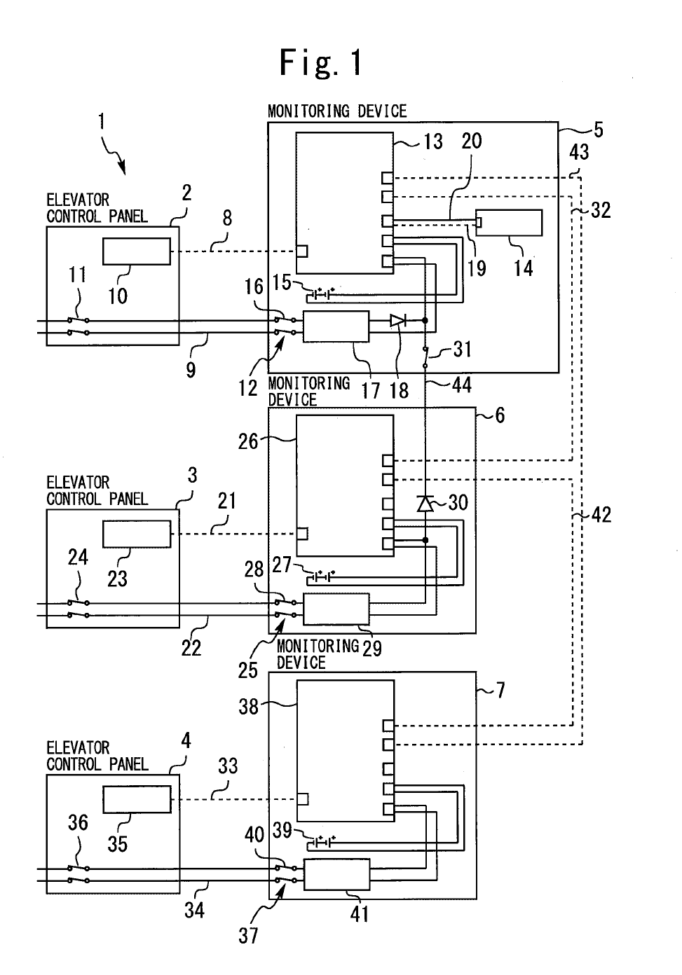

FIG. 1 is a diagram illustrating an example of a monitoring system 1 according to Embodiment 1 of this invention. FIG. 1 illustrates an example in which the monitoring system 1 includes three elevator devices. For example, the monitoring system 1 includes Elevator A, Elevator B, and Elevator C as elevator devices to be monitored. The number of elevator devices included in the monitoring system 1 is not limited to three. For example, the monitoring system 1 may include two elevator devices. The monitoring system 1 may include four or more elevator devices. In the example indicated in the present embodiment, the monitoring system 1 includes, for example, an elevator control panel 2, an elevator control panel 3, an elevator control panel 4, a monitoring device 5, a monitoring device 6 and a monitoring device 7.

The elevator control panel 2 controls operations of Elevator A. For example, the elevator control panel 2 controls a normal operation, a diagnostic operation and an emergency operation. The monitoring device 5 is paired with the elevator control panel 2. The monitoring device 5 monitors Elevator A. The monitoring device 5 is connected to the elevator control panel 2. For example, the monitoring device 5 is connected to the elevator control panel 2 via a communication wire 8. The monitoring device 5 can bidirectionally communicate with the elevator control panel 2. The monitoring device 5 is connected to the elevator control panel 2 via a power supply wire 9. Power necessary for the monitoring device 5 is supplied from the elevator control panel 2.

In FIG. 1, etc., each communication wire is indicated by a dashed line. Also, each power supply wire is indicated by a solid line.

The elevator control panel 2 includes, for example, a control circuit 10 and a switch 11. Control for a normal operation, a diagnostic operation, and an emergency operation is performed by the control circuit 10. The control circuit 10 detects various information in each operation. For example, the control circuit 10 detects occurrence of entrapment. The control circuit 10 detects occurrence of an abnormality in the elevator device. The communication wire 8 is connected to the control circuit 10. The control circuit 10 transmits the detected information to the monitoring device 5 via the communication wire 8.

The switch 11 is connected to the power supply wire 9. If the switch 11 is closed, power is supplied from the elevator control panel 2 to the monitoring device 5. If the switch 11 is open, no power is supplied from the elevator control panel 2 to the monitoring device 5. The switch 11 is opened by a maintenance worker, for example, when maintenance on Elevator A is performed.

The monitoring device 5 includes, for example, a power supply circuit 12, a control circuit 13, a communication circuit 14 and a storage battery 15.

The power supply circuit 12 supplies power from the elevator control panel 2 to the control circuit 13. The power supply wire 9 is connected to the power supply circuit 12. The power supply circuit 12 includes, for example, a switch 16, a transformer 17 and a diode 18. The transformer 17 transforms an AC voltage from the elevator control panel 2 into a DC voltage. The transformer 17 is connected to the power supply wire 9 via the switch 16. The diode 18 is connected between the transformer 17 and the control circuit 13. For example, an anode of the diode 18 is connected to the transformer 17. A cathode of the diode 18 is connected to the control circuit 13.

The control circuit 13 performs control necessary for monitoring of Elevator A. For example, the communication wire 8 is connected to the control circuit 13. Information transmitted from the control circuit 10 is received by the control circuit 13. The control circuit 13 causes the received information to be stored in a memory (not illustrated). For example, a maintenance worker can retrieve information stored in the memory by connecting a dedicated device to the monitoring device 5.

The communication circuit 14 performs communication with a monitoring center (not illustrated). The monitoring center is provided at, for example, a maintenance service provider that provides maintenance services for the elevator devices. The monitoring center may be provided at a building in which the elevator devices are installed. For example, information from the monitoring system 1 and information from other monitoring systems are aggregated in the monitoring center.

The communication circuit 14 is connected to the control circuit 13 by a communication wire 19. The control circuit 13 controls the communication circuit 14. For example, the control circuit 13 causes the communication circuit 14 to transmit information received from the elevator control panel 2 and the like to the monitoring center. The communication circuit 14 is connected to the control circuit 13 via a power supply wire 20. Power necessary for the communication circuit 14 is supplied from the control circuit 13.

In an emergency, the storage battery 15 supplies power to the control circuit 13. For example, upon occurrence of a blackout, power is supplied from the storage battery 15 to the control circuit 13. In such case, the control circuit 13 supplies power from the storage battery 15 to the communication circuit 14 via the power supply wire 20.

The elevator control panel 3 controls operations of Elevator B. For example, the elevator control panel 3 controls a normal operation, a diagnostic operation and an emergency operation. The monitoring device 6 is paired with the elevator control panel 3. The monitoring device 6 monitors Elevator B. The monitoring device 6 is connected to the elevator control panel 3. For example, the monitoring device 6 is connected to the elevator control panel 3 via a communication wire 21. The monitoring device 6 can bidirectionally communicate with the elevator control panel 3. The monitoring device 6 is connected to the elevator control panel 3 via a power supply wire 22. Power necessary for the monitoring device 6 is supplied from the elevator control panel 3.

The elevator control panel 3 includes, for example, a control circuit 23 and a switch 24. Control for a normal operation, a diagnostic operation, and an emergency operation is performed by the control circuit 23. In each operation, the control circuit 23 detects various information. For example, the control circuit 23 detects occurrence of entrapment. The control circuit 23 detects occurrence of an abnormality in the elevator device. The communication wire 21 is connected to the control circuit 23. The control circuit 23 transmits the detected information to the monitoring device 6 via the communication wire 21.

The switch 24 is connected to the power supply wire 22. If the switch 24 is closed, power is supplied from the elevator control panel 3 to the monitoring device 6. If the switch 24 is open, no power is supplied from the elevator control panel 3 to the monitoring device 6. The switch 24 is opened by a maintenance worker, for example, when maintenance on Elevator B is performed.

The monitoring device 6 includes, for example, a power supply circuit 25, a control circuit 26 and a storage battery 27.

The power supply circuit 25 supplies power from the elevator control panel 3 to the control circuit 26. The power supply wire 22 is connected to the power supply circuit 25. The power supply circuit 25 includes, for example, a switch 28, a transformer 29 and a diode 30. The transformer 29 transforms an AC voltage from the elevator control panel 3 into a DC voltage. The transformer 29 is connected to the power supply wire 22 via the switch 28. The diode 30 is connected between the transformer 29 and the control circuit 13. An anode of the diode 30 is connected to the transformer 29. In the example illustrated in FIG. 1, the anode of the diode 30 is connected to a power supply wire connecting the transformer 29 and the control circuit 26. A cathode of the diode 30 is connected to the cathode of the diode 18. In the example illustrated in FIG. 1, the cathode of the diode 30 is connected to a power supply wire connecting the diode 18 and the control circuit 13 via a switch 31.

The control circuit 26 performs control necessary for monitoring of Elevator B. For example, the communication wire 21 is connected to the control circuit 26. Information transmitted from the control circuit 23 is received by the control circuit 26. The control circuit 26 causes the received information to be stored in a memory (not illustrated). For example, a maintenance worker can retrieve information stored in the memory by connecting a dedicated device to the monitoring device 6.

The control circuit 26 is connected to the control circuit 13 of the monitoring device 5 by a communication wire 32. The control circuit 13 and the control circuit 26 can bidirectionally communicate with each other. For example, the control circuit 26 transmits information received from the elevator control panel 3 to the control circuit 13 via the communication wire 32. The control circuit 13 transmits information received from the monitoring center to the control circuit 26 via the communication wire 32.

In an emergency, the storage battery 27 supplies power to the control circuit 26. For example, upon occurrence of a blackout, power is supplied from the storage battery 27 to the control circuit 26.

The elevator control panel 4 controls operations of Elevator C. For example, the elevator control panel 4 controls a normal operation, a diagnostic operation and an emergency operation. The monitoring device 7 is paired with the elevator control panel 4. The monitoring device 7 monitors Elevator C. The monitoring device 7 is connected to the elevator control panel 4. For example, the monitoring device 7 is connected to the elevator control panel 4 via a communication wire 33. The monitoring device 7 can bidirectionally communicate with the elevator control panel 4. The monitoring device 7 is connected to the elevator control panel 4 by a power supply wire 34. Power necessary for the monitoring device 7 is supplied from the elevator control panel 4.

The elevator control panel 4 includes, for example, a control circuit 35 and a switch 36. Control for a normal operation, a diagnostic operation, and an emergency operation is performed by the control circuit 35. In each operation, the control circuit 35 detects various information. For example, the control circuit 35 detects occurrence of entrapment. The control circuit 35 detects occurrence of an abnormality in the elevator device. The communication wire 33 is connected to the control circuit 35. The control circuit 35 transmits the detected information to the monitoring device 7 via the communication wire 33.

The switch 36 is connected to the power supply wire 34. If the switch 36 is closed, power is supplied from the elevator control panel 4 to the monitoring device 7. If the switch 36 is open, no power is supplied from the elevator control panel 4 to the monitoring device 7. The switch 36 is opened by a maintenance worker, for example, when maintenance on Elevator C is performed.

The monitoring device 7 includes, for example, a power supply circuit 37, a control circuit 38 and a storage battery 39.

The power supply circuit 37 supplies power from the elevator control panel 4 to the control circuit 38. The power supply wire 34 is connected to the power supply circuit 37. The power supply circuit 37 includes, for example, a switch 40 and a transformer 41. The transformer 41 transforms an AC voltage from the elevator control panel 4 into a DC voltage. The transformer 41 is connected to the power supply wire 34 via the switch 40.

The control circuit 38 performs control necessary for monitoring of Elevator C. For example, the communication wire 33 is connected to the control circuit 38. Information transmitted from the control circuit 35 is received by the control circuit 38. The control circuit 38 causes the received information to be stored in a memory (not illustrated). For example, a maintenance worker can retrieve information stored in the memory by connecting a dedicated device to the monitoring device 7.

The control circuit 38 is connected to the control circuit 26 of the monitoring device 6 via a communication wire 42. The control circuit 26 and the control circuit 38 can bidirectionally communicate with each other.

The control circuit 38 is connected to the control circuit 13 of the monitoring device 5 via a communication wire 43. The control circuit 13 and the control circuit 38 can bidirectionally communicate with each other. For example, the control circuit 38 transmits information received from the elevator control panel 4 to the control circuit 13 via the communication wire 43. The control circuit 13 transmits information received from the monitoring center to the control circuit 38 via the communication wire 43.

The control circuit 13 of the monitoring device 5, the control circuit 26 of the monitoring device 6, and the control circuit 38 of the monitoring device 7 are connected in a ring-like form by the communication wire 32, the communication wire 42, and the communication wire 43. Communication between the monitoring device 5, the monitoring device 6, and the monitoring device 7 may be limited to unidirectional communication. Also, the form of connection of the control circuit 13, the control circuit 26, and the control circuit 38 is not limited to ring-like connection. For example, the control circuit 13, the control circuit 26, and the control circuit 38 may be connected in a mesh form or a star-like form, via communication wires. The control circuit 13, the control circuit 26, and the control circuit 38 only need to be connected via the communication wires so that information can be transmitted to the control circuit 13.

In an emergency, the storage battery 39 supplies power to the control circuit 38. For example, upon occurrence of a blackout, power is supplied from the storage battery 39 to the control circuit 38.

The example indicated in the present embodiment enables supply of power from the elevator control panel 2 to the communication circuit 14 for communication with the monitoring center. Thus, there is no need to provide a power supply necessary only for the communication circuit 14.

If only power from the elevator control panel 2 can be supplied to the communication circuit 14, when the power to the elevator control panel 2 is shut down, the supply of power to the communication circuit 14 fails. In other words, if the power to the elevator control panel 2 is shut down, communication with the monitoring center cannot be performed. For example, when a maintenance worker performs maintenance on Elevator A, the maintenance worker opens the switch 11 to shut down the power to the elevator control panel 2.

In the example indicated in the present embodiment, even when the power to the elevator control panel 2 is shut down, power is supplied to the communication circuit 14. In other words, if the supply of power from the power supply circuit 12 to the control circuit 13 fails, power from the elevator control panel 3 is supplied from the power supply circuit 25 to the control circuit 13. Thus, power necessary for communication is supplied to the communication circuit 14. Even when maintenance on Elevator A is performed, the monitoring system 1 can communicate with the monitoring center.

In the example indicated in the present embodiment, for example, a transformer that is identical to the transformer 17 is used as the transformer 29. A diode that is identical to the diode 18 is used as the diode 30. Between the diode 30 and the diode 18, there is a power supply wire 44 connecting the monitoring device 5 and the monitoring device 6. If the power to the elevator control panel 2 is not shut down, the power from the power supply circuit 12 is preferentially supplied to the control circuit 13 because of a voltage drop due to the power supply wire 44. If the supply of power from the power supply circuit 12 to the control circuit 13 fails, power from the power supply circuit 25 is supplied to the control circuit 13.

Also, if both the power supply from the power supply circuit 12 to the control circuit 13 and the power supply from the power supply circuit 25 to the control circuit 13 fail, power is supplied from the storage battery 15 to the control circuit 13. For example, upon occurrence of a blackout, power from the storage battery 15 is supplied to the control circuit 13. Likewise, if supply of power from the power supply circuit 25 to the control circuit 26 fails, power is supplied from the storage battery 27 to the control circuit 26. If supply of power from the power supply circuit 37 to the control circuit 38 fails, power is supplied from the storage battery 39 to the control circuit 38.

In the example illustrated in the present embodiment, the monitoring system 1 includes three elevator devices. If the monitoring system 1 includes two elevator devices, the elevator control panel 4 and the monitoring device 7 may be deleted from the example illustrated in FIG. 1. In such case, neither the communication wire 42 nor the communication wire 43 is needed.

If the monitoring system 1 includes four or more elevator devices, the monitoring system 1 may include plural sets of an elevator control panel 4 and a monitoring device 7. In other words, the monitoring system 1 includes a plurality of elevator control panels 4. The monitoring system 1 includes a number of monitoring devices 7, the number being equal to the number of elevator control panels 4. The monitoring devices 7 are connected to the respective elevator control panels 4 on a one-to-one basis. In each monitoring device 7, a power supply circuit 37 supplies power from the counterpart elevator control panel 4 to a control circuit 38. The control circuit 13, the control circuit 26, and the control circuits 38 are connected, for example, in a ring-like form by communication wires so that information can be transmitted to the control circuit 13.

### Embodiment 2

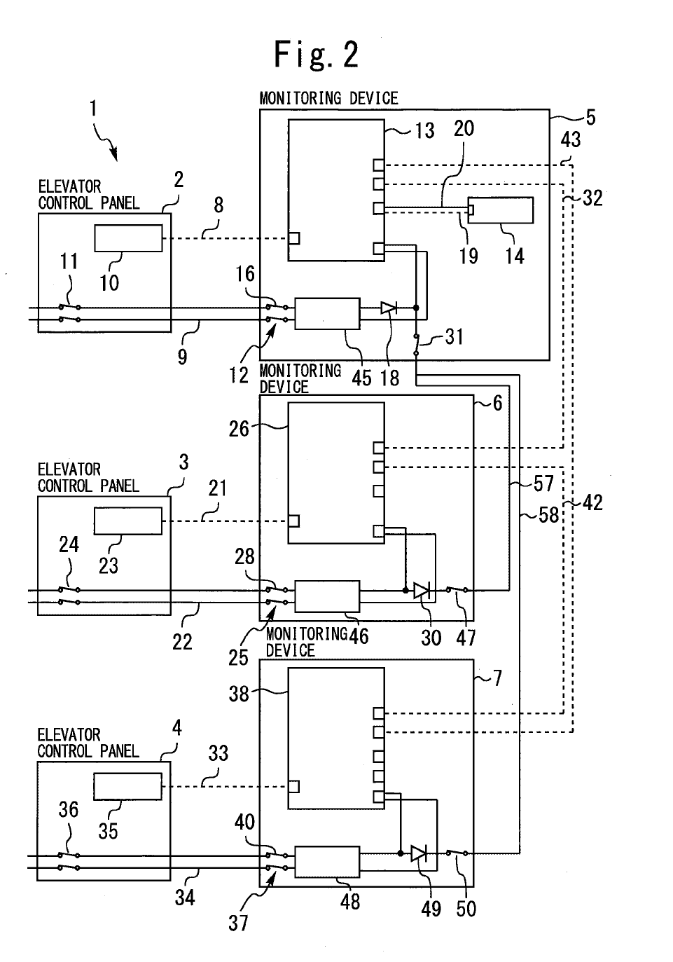

FIG. 2 is a diagram illustrating an example of the monitoring system 1 according to Embodiment 2 of this invention. FIG. 2 illustrates an example in which the monitoring system 1 includes three elevator devices. The number of elevator devices included in the monitoring system 1 is not limited to three. In the present embodiment, differences from the example illustrated in Embodiment 1 will be described in detail. In the following embodiments, description of matters already described will arbitrarily be omitted. The monitoring system 1 includes, for example, the elevator control panel 2, the elevator control panel 3, the elevator control panel 4, the monitoring device 5, the monitoring device 6, and a monitoring device 7.

In the example illustrated in the present embodiment, the monitoring device 5 includes, for example, the power supply circuit 12, the control circuit 13, and the communication circuit 14.

The power supply circuit 12 supplies power from the elevator control panel 2 to the control circuit 13. The power supply circuit 12 includes, for example, the switch 16, a UPS 45, and the diode 18. The UPS 45 is an abbreviation of an uninterruptible power supply. The UPS 45 transforms an AC voltage from the elevator control panel 2 into a DC voltage. The UPS 45 can continue externally supplying power for a certain length of time even if the power supply is discontinued. Thus, in the example indicated in the present embodiment, the monitoring device 5 includes no storage battery 15.

The UPS 45 is connected to the power supply wire 9 via the switch 16. The diode 18 is connected between the UPS 45 and the control circuit 13. For example, the anode of the diode 18 is connected to the UPS 45. The cathode of the diode 18 is connected to the control circuit 13. The control circuit 13 controls the communication circuit 14. Power necessary for the communication circuit 14 is supplied from the control circuit 13.

The monitoring device 6 includes, for example, the power supply circuit 25 and the control circuit 26.

The power supply circuit 25 supplies power from the elevator control panel 3 to the control circuit 26. The power supply circuit 25 includes, for example, the switch 28, a UPS 46, and the diode 30. Since the power supply circuit 25 includes the UPS 46, the monitoring device 6 includes no storage battery 27. The UPS 46 transforms an AC voltage from the elevator control panel 3 into a DC voltage.

The UPS 46 is connected to the power supply wire 22 via the switch 28. The diode 30 is connected between the UPS 46 and the control circuit 13. The anode of the diode 30 is connected to the UPS 46. In the example illustrated in FIG. 2, the anode of the diode 30 is connected to a power supply wire connecting the UPS 46 and the control circuit 26. The cathode of the diode 30 is connected to the cathode of the diode 18. In the example illustrated in FIG. 2, the cathode of the diode 30 is connected to a power supply wire connecting the diode 18 and the control circuit 13, via the switch 31 and a switch 47.

The monitoring device 7 includes, for example, the power supply circuit 37 and the control circuit 38.

The power supply circuit 37 supplies power from the elevator control panel 4 to the control circuit 38. The power supply circuit 37 includes, for example, the switch 40 and a UPS 48. Since the power supply circuit 37 includes the UPS 48, the monitoring device 7 includes no storage battery 39. The UPS 48 transforms an AC voltage from the elevator control panel 4 into a DC voltage. The UPS 48 is connected to the power supply wire 34 via the switch 40.

The control circuit 13 of the monitoring device 5, the control circuit 26 of the monitoring device 6, and the control circuit 38 of the monitoring device 7 are connected, for example, in a ring-like form, by the communication wire 32, the communication wire 42, and the communication wire 43.

Even in the example illustrated in FIG. 2, power from the elevator control panel 2 can be supplied to the communication circuit 14. Therefore, there is no need to provide a power supply necessary only for the communication circuit 14. Also, even if the power to the elevator control panel 2 is shut down, power is supplied to the communication circuit 14. In other words, if the supply of power from the power supply circuit 12 to the control circuit 13 fails, power from the elevator control panel 3 is supplied from the power supply circuit 25 to the control circuit 13. Thus, power necessary for communication is also supplied to the communication circuit 14. The monitoring system 1 can communicate with the monitoring center even when maintenance on Elevator A is performed.

Furthermore, in the example illustrated in FIG. 2, the power supply circuit 37 includes a diode 49. The diode 49 is connected between the UPS 48 and the control circuit 13. An anode of the diode 49 is connected to the UPS 48. In the example illustrated in FIG. 2, the anode of the diode 49 is connected to a power supply wire connecting the UPS 48 and the control circuit 38. A cathode of the diode 49 is connected to the cathode of the diode 18. In the example illustrated in FIG. 2, the cathode of the diode 49 is connected to a power supply wire connecting the diode 18 and the control circuit 13, via the switch 31 and a switch 50.

In the example illustrated in FIG. 2, for example, if both the power supply from the power supply circuit 12 to the control circuit 13 and the power supply from the power supply circuit 25 to the control circuit 13 fail, power from the elevator control panel 4 is supplied from the power supply circuit 37 to the control circuit 13. Therefore, even if both of the power to the elevator control panel 2 and the power to the elevator control panel 3 are shut down, power can be supplied to the control circuit 13 and the communication circuit 14. The possibility of failure to communicate with the monitoring center can further be reduced. For example, even if maintenance on Elevator A and maintenance on Elevator B are performed simultaneously, the monitoring system 1 can communicate with the monitoring center.

In the example illustrated in FIG. 2, the power supply circuit 12 includes the UPS 45. Thus, even if the power to the elevator control panel 2 is shut down, power is supplied from the power supply circuit 12 to the control circuit 13 until a lapse of the certain length of time. If power can be supplied to the control circuit 13 only from the power supply circuit 12 and the power supply circuit 25, for example, upon occurrence of a blackout during maintenance on Elevator A being performed, the power supply to the control circuit 13 is immediately stopped. Therefore, if UPSs are included in power supply circuits of monitoring devices, it is preferable that a largest possible number of power supply circuits can supply power to the control circuit 13.

In the example indicated in Embodiment 1, also, as in the example indicated in the present embodiment, power may be supplied from the power supply circuit 37 to the control circuit 13. In such case, the power supply circuit 37 includes the diode 49 in addition to the switch 40 and the transformer 41. The diode 49 is connected between the transformer 41 and the control circuit 13. The anode of the diode 49 is connected to the transformer 41. For example, the anode of the diode 49 is connected to a power supply wire connecting the transformer 41 and the control circuit 38. The cathode of the diode 49 is connected to the cathode of the diode 18. For example, the cathode of the diode 49 is connected to the power supply wire connecting the diode 18 and the control circuit 13, via the switch 31 and the switch 50.

In the example illustrated in Embodiment 1, where the power supply circuit 37 includes the diode 49, if all of the power supply from the power supply circuit 12 to the control circuit 13, the power supply from the power supply circuit 25 to the control circuit 13, and the power supply from the power supply circuit 37 to the control circuit 13 fail, power is supplied from the storage battery 15 to the control circuit 13.

In the example indicated in the present embodiment, the monitoring system 1 includes three elevator devices. If the monitoring system 1 include two elevator devices, the elevator control panel 4 and the monitoring device 7 may be deleted from the example illustrated in FIG. 2. In such case, neither the communication wire 42 nor the communication wire 43 is needed.

If the monitoring system 1 includes four or more elevator devices, the monitoring system 1 may include plural sets of an elevator control panel 4 and a monitoring device 7. In other words, the monitoring system 1 includes a plurality of elevator control panels 4. The monitoring system 1 includes a number of monitoring devices 7, the number being equal to the number of elevator control panels 4. The monitoring devices 7 are connected to the respective elevator control panels 4 on a one-to-one basis. In each monitoring device 7, a power supply circuit 37 supplies power from the counterpart elevator control panel 4 to a control circuit 38. The control circuit 13, the control circuit 26, and the control circuits 38 are connected, for example, in a ring-like form via communication wires so that information can be transmitted to the control circuit 13. A diode 49 is connected between each UPS 48 and the control circuit 13.

In the examples indicated in the present embodiment and Embodiment 1, if the monitoring system 1 includes a plurality of monitoring devices 7, it is not necessary that the power supply circuits 37 of all of the monitoring devices 7 include a diode 49. Some of the power supply circuits 37 may include a diode 49. For example, one power supply circuit 37 alone may include a diode 49.

### Embodiment 3

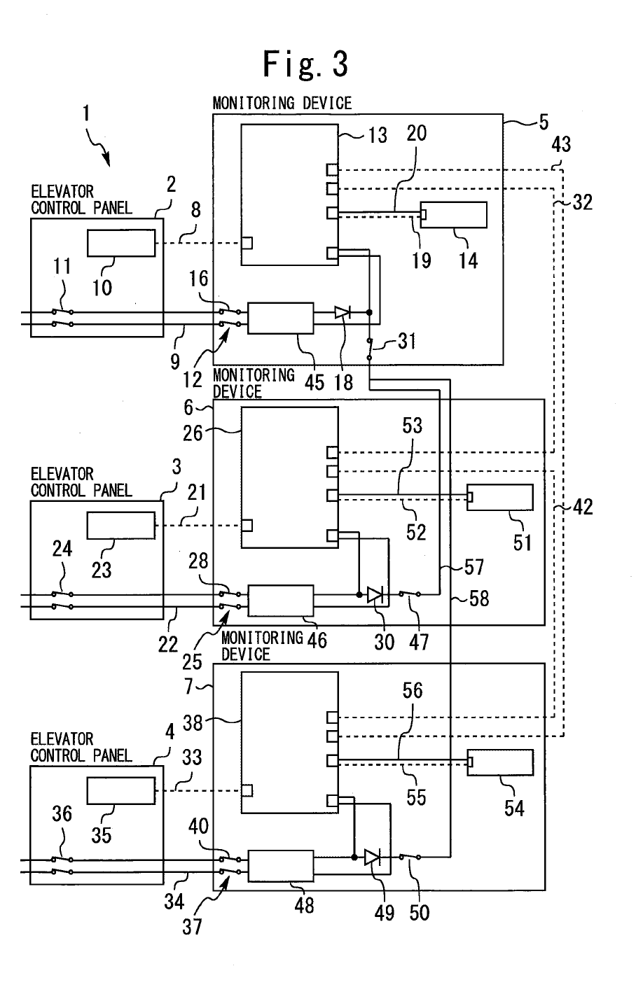

FIG. 3 is a diagram illustrating an example of the monitoring system 1 according to Embodiment 3 of this invention. The monitoring system 1 according to the present embodiment is different from the examples indicated in Embodiment 1 or Embodiment 2 in the monitoring system 1 including a plurality of communication circuits. For a configuration of the monitoring system 1 except the difference, either of the configuration disclosed in Embodiment 1 and the configuration disclosed in Embodiment 2 may be employed. In the present embodiment, the difference from the examples indicated in Embodiment 1 or Embodiment 2 will be described in detail.

FIG. 3 illustrates an example in which the configuration of the monitoring system 1 is the same as the example illustrated in FIG. 2 except the difference. The number of elevator devices included in the monitoring system 1 is not limited to three. Each power supply circuit may include a transformer or an UPS. The power supply circuit 37 may include the diode 49 or may include no diode 49. If the monitoring system 1 includes a plurality of monitoring devices 7, some of the power supply circuits 37 alone may include the diode 49.

The monitoring system 1 includes, for example, the elevator control panel 2, the elevator control panel 3, the elevator control panel 4, the monitoring device 5, the monitoring device 6, and the monitoring device 7. The monitoring device 6 includes, for example, the power supply circuit 25, the control circuit 26, and a communication circuit 51.

The power supply circuit 25 supplies power from the elevator control panel 3 to the control circuit 26. The communication circuit 51 communicates with the monitoring center. The communication circuit 51 is connected to the control circuit 26 via a communication wire 52. The control circuit 26 controls the communication circuit 51. For example, the control circuit 26 causes the communication circuit 51 to transmit information received from the elevator control panel 3 and the like to the monitoring center. The communication circuit 51 is connected to the control circuit 26 via a power supply wire 53. Power necessary for the communication circuit 51 is supplied from the control circuit 26.

The communication circuit 51 is provided as a spare of, for example, the communication circuit 14. Thus, if communication with the monitoring center can be performed by the communication circuit 14, the communication circuit 51 is not used. The communication circuit 51 is used, for example, when maintenance on the monitoring device 5 is performed.

The monitoring device 7 includes, for example, the power supply circuit 37, the control circuit 38, and a communication circuit 54.

The power supply circuit 37 supplies power from the elevator control panel 4 to the control circuit 38. The communication circuit 54 performs communication with the monitoring center. The communication circuit 54 is connected to the control circuit 38 via a communication wire 55. The control circuit 38 controls the communication circuit 54. For example, the control circuit 38 causes the communication circuit 54 to transmit information received from the elevator control panel 4 and the like to the monitoring center. The communication circuit 54 is connected to the control circuit 38 by a power supply wire 56. Power necessary for the communication circuit 54 is supplied from the control circuit 38.

The communication circuit 54 is provided as a spare of, for example, the communication circuit 14. Thus, if communication with the monitoring center can be performed by the communication circuit 14, the communication circuit 54 is not used. The communication circuit 54 is used, for example, when maintenance on the monitoring device 5 and the monitoring device 6 is performed.

If the monitoring system 1 includes a plurality of communication circuits, the monitoring system 1 can communicate with the monitoring center even during maintenance on a monitoring device being performed. If the monitoring system 1 includes the communication circuit 14 as a main communication circuit, the monitoring system 1 may include the communication circuit 51 and include no communication circuit 54. The monitoring system 1 may include the communication circuit 54 and include no communication circuit 51. If the monitoring system 1 includes a plurality of communication circuits other than the communication circuit 14, the plurality of communication circuits may be prioritized to use the plurality of communication circuits in order of priority.

If the monitoring system 1 includes a plurality of monitoring devices 7, not all of the monitoring devices 7 need to include a communication circuit 54. Some of the monitoring devices 7 may include a communication circuit 54. For example, one monitoring device 7 alone may include a communication circuit 54.

### Embodiment 4

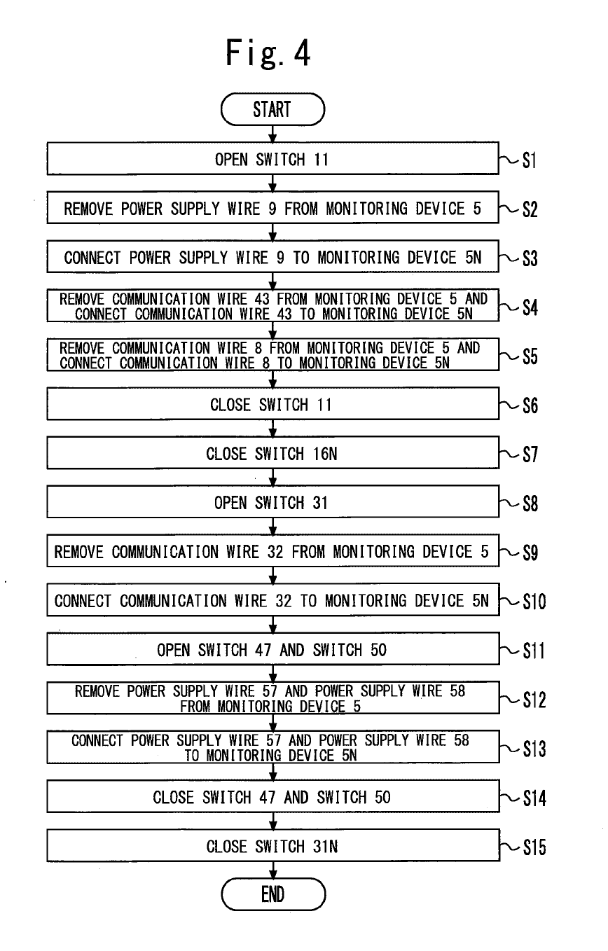

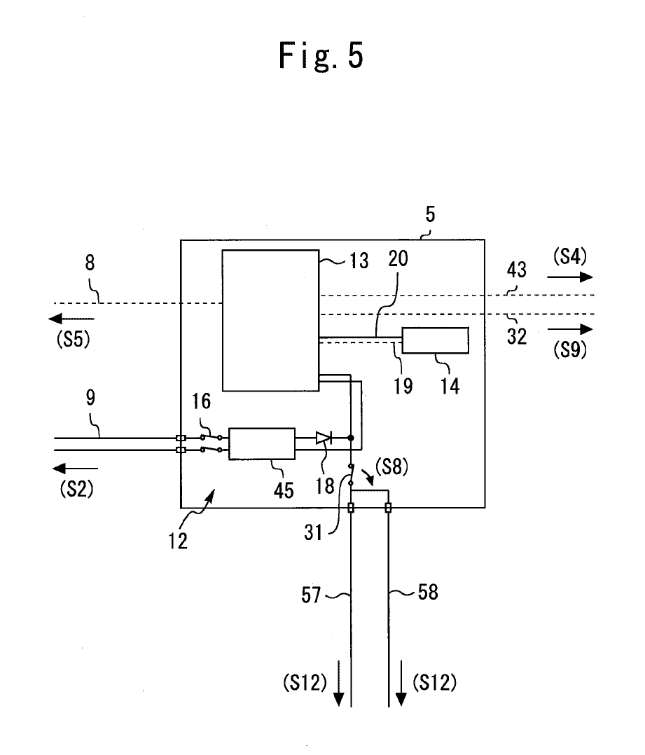

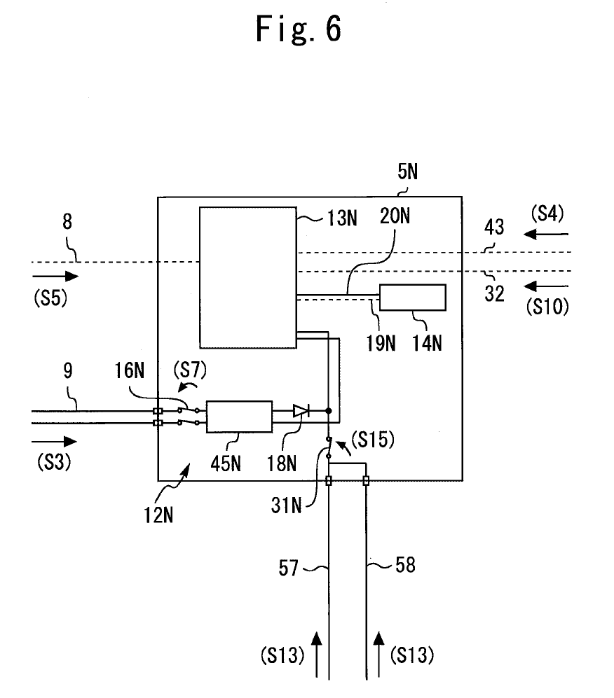

The present embodiment will be described in terms of procedure for replacing the monitoring device 5. For a configuration of the monitoring system 1, any of the configurations disclosed in Embodiments 1 to 3 may be employed. FIG. 4 is a flowchart illustrating a procedure for replacing the monitoring device 5. FIGS. 5 and 6 are diagrams for describing the procedure for replacing the monitoring device 5. FIG. 5 is a state before replacement of the monitoring device 5. FIG. 6 is a state after replacement of the monitoring device 5. In the description of the present embodiment, reference numerals for a monitoring device after replacement are added with “N” to distinguish the monitoring device from a monitoring device before the replacement. In other words, the monitoring device 5 before replacement includes the power supply circuit 12, the control circuit 13, and the communication circuit 14. The monitoring device 5N after replacement includes a power supply circuit 12N, a control circuit 13N, and a communication circuit 14N.

Work for replacing the monitoring device 5 with the monitoring device 5N is performed, for example, when maintenance on Elevator A is performed. A maintenance worker first opens the switch 11 (S1). Consequently, supply of power from the elevator control panel 2 to the monitoring device 5 fails. Upon power supply from the elevator control panel 2 to the monitoring device 5 being interrupted, power is supplied from the power supply circuit 25 of the monitoring device 6 to the control circuit 13 of the monitoring device 5. The communication circuit 14 is supplied with power from the control circuit 13.

Next, the maintenance worker removes the power supply wire 9 from the monitoring device 5 (S2). The maintenance worker connects the power supply wire 9 removed from the monitoring device 5, to the new monitoring device 5N (S3). Consequently, the power supply wire 9 is electrically connected to the power supply circuit 12N of the monitoring device 5N. At the time of connecting the power supply wire 9 to the monitoring device 5N, a switch 16N is open.

Next, the maintenance worker removes the communication wire 43 from the monitoring device 5. The maintenance worker connects the communication wire 43 removed from the monitoring device 5, to the monitoring device 5N (S4). The communication wire 43 is connected to the control circuit 13N.

Next, the maintenance worker removes the communication wire 8 from the monitoring device 5. The maintenance worker connects the communication wire 8 removed from the monitoring device 5, to the monitoring device 5N (S5). The communication wire 8 is connected to the control circuit 13N.

Next, the maintenance worker closes the switch 11 (S6). Consequently, supply of power from the elevator control panel 2 to the control circuit 13N of the monitoring device 5N is enabled. After closing the switch 11, the maintenance worker closes the switch 16N of the monitoring device 5N (S7). Consequently, power from the elevator control panel 2 is supplied from the power supply circuit 12N to the control circuit 13N. The communication circuit 14N is supplied with power from the control circuit 13N.

Upon power being supplied from the elevator control panel 2, the control circuit 13N switches a communication circuit that communicates with the monitoring center from the communication circuit 14 to the communication circuit 14N.

Next, the maintenance worker opens the switch 31 (S8). Consequently, the power supply from the monitoring device 6 to the monitoring device 5 is interrupted. The power supply to the monitoring device 5 fails.

Next, the maintenance worker removes the communication wire 32 from the monitoring device 5 (S9). The maintenance worker connects the communication wire 32 removed from the monitoring device 5, to the monitoring device 5N (S10). The communication wire 32 is connected to the control circuit 13N.

Next, the maintenance worker opens the switch 47 and the switch 50 (S11). After opening the switch 47 and the switch 50, the maintenance worker removes a power supply wire 57 and a power supply wire 58 from the monitoring device 5 (S12). The power supply wire 57 is a power supply wire for connecting the switch 31 and the switch 47. The power supply wire 58 is a power supply wire for connecting the switch 31 and the switch 50. The maintenance worker connects the power supply wire 57 and the power supply wire 58 removed from the monitoring device 5, to the monitoring device 5N (S13). Consequently, the power supply wire 57 and the power supply wire 58 are electrically connected to a switch 31N. At the time of connecting the power supply wire 57 and the power supply wire 58 to the monitoring device 5N, the switch 31N is open.

Next, the maintenance worker closes the switch 47 and the switch 50 (S14). Also, the maintenance worker closes the switch 31N (S15). Consequently, supply of power from the elevator control panel 3 from the power supply circuit 25 to the control circuit 13N is enabled. For example, if supply of power from the power supply circuit 12N to the control circuit 13N fails, power from the elevator control panel 3 is supplied from the power supply circuit 25 to the control circuit 13N.

According to the example indicated in the present embodiment, the monitoring system 1 can communicate with the monitoring center even during replacement of the monitoring device 5 with the new monitoring device 5N.

### Embodiment 5

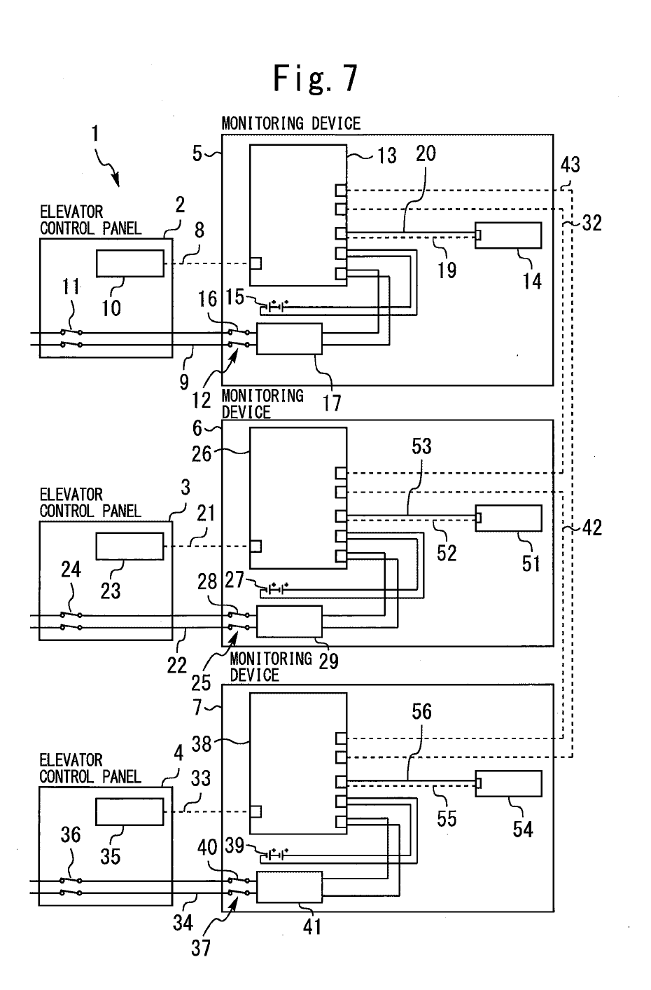

FIG. 7 is a diagram illustrating an example of the monitoring system 1 according to Embodiment 5 of this invention. The monitoring system 1 according to the present embodiment is different from the examples indicated in Embodiment 1 or Embodiment 2 in the monitoring system 1 including a plurality of communication circuits. Also, the monitoring system 1 according to the present embodiment is different from the examples indicated in Embodiments 1 to 3 in the control circuit 13 of the monitoring device 5 being not supplied with power from a control circuit of another monitoring device. For a configuration of the monitoring system 1 except the aforementioned differences, any of the configurations disclosed in Embodiments 1 to 3 may be employed.

The monitoring system 1 includes, for example, the elevator control panel 2, the elevator control panel 3, the elevator control panel 4, the monitoring device 5, the monitoring device 6, and the monitoring device 7.

The monitoring device 5 includes, for example, the power supply circuit 12, the control circuit 13, the communication circuit 14, and the storage battery 15. The power supply circuit 12 supplies power from the elevator control panel 2 to the control circuit 13. The power supply circuit 12 includes, for example, the switch 16 and the transformer 17. The transformer 17 transforms an AC voltage from the elevator control panel 2 into a DC voltage. The power supply circuit 12 includes no diode 18. The communication circuit 14 communicates with the monitoring center. The control circuit 13 controls the communication circuit 14. Power necessary for the communication circuit 14 is supplied from the control circuit 13. If the supply of power from the power supply circuit 12 to the control circuit 13 fails, the storage battery 15 supplies power to the control circuit 13.

The power supply circuit 12 may include the UPS 45. The UPS 45 transforms an AC voltage from the elevator control panel 2 into a DC voltage. If the power supply circuit 12 includes the UPS 45, the monitoring device 5 does not need to include the storage battery 15.

The monitoring device 6 includes, for example, the power supply circuit 25, the control circuit 26, the communication circuit 51, and the storage battery 27. The power supply circuit 25 supplies power from the elevator control panel 3 to the control circuit 26. The power supply circuit 25 includes, for example, the switch 28 and the transformer 29. The transformer 29 transforms an AC voltage from the elevator control panel 3 into a DC voltage. The power supply circuit 25 includes no diode 30. The communication circuit 51 communicates with the monitoring center. The control circuit 26 controls the communication circuit 51. Power necessary for the communication circuit 51 is supplied from the control circuit 26. If the supply of power from the power supply circuit 25 to the control circuit 26 fails, the storage battery 27 supplies power to the control circuit 26.

The power supply circuit 25 may include the UPS 46. The UPS 46 transforms an AC voltage from the elevator control panel 3 into a DC voltage. If the power supply circuit 25 includes the UPS 46, the monitoring device 6 does not need to include the storage battery 27.

The monitoring device 7 includes, for example, the power supply circuit 37, the control circuit 38, the communication circuit 54, and the storage battery 39. The power supply circuit 37 supplies power from the elevator control panel 4 to the control circuit 38. The power supply circuit 37 includes, for example, the switch 40 and the transformer 41. The transformer 41 transforms an AC voltage from the elevator control panel 4 into a DC voltage. The power supply circuit 37 includes no diode 49. The communication circuit 54 communicates with the monitoring center. The control circuit 38 controls the communication circuit 54. Power necessary for the communication circuit 54 is supplied from the control circuit 38. If the supply of power from the power supply circuit 37 to the control circuit 38 fails, the storage battery 39 supplies power to the control circuit 38.

The power supply circuit 37 may include the UPS 48. The UPS 48 transforms an AC voltage from the elevator control panel 4 into a DC voltage. If the power supply circuit 37 includes the UPS 48, the monitoring device 7 does not need to include the storage battery 39.

The control circuit 13 of the monitoring device 5, the control circuit 26 of the monitoring device 6, and the control circuit 38 of the monitoring device 7 are connected, for example, in a ring-like form via the communication wire 32, the communication wire 42, and the communication wire 43. Communication between the monitoring device 5, the monitoring device 6, and the monitoring device 7 may be limited to unidirectional communication.

According to the example indicated in the present embodiment, power from the elevator control panel 2 can be supplied to the communication circuit 14 for communication with the monitoring center. Therefore, there is no need to provide a power supply necessary only for the communication circuit 14. Likewise, power from the elevator control panel 3 can be supplied to the communication circuit 51. Power from the elevator control panel 4 can be supplied to the communication circuit 54.

In the example illustrated in FIG. 7, the monitoring system 1 includes three elevator devices. If the monitoring system 1 includes two elevator devices, the elevator control panel 4 and the monitoring device 7 may be deleted from the example illustrated in FIG. 7. In such case, neither the communication wire 42 nor the communication wire 43 is needed.

If the monitoring system 1 includes four or more elevator devices, the monitoring system 1 may include plural sets of an elevator control panel 4 and a monitoring device 7. In other words, the monitoring system 1 includes a plurality of elevator control panels 4. The monitoring system 1 includes a number of monitoring devices 7, the number being equal to the number of elevator control panels 4. The monitoring devices 7 are connected to the respective elevator control panels 4 on a one-to-one basis. In each monitoring device 7, a power supply circuit 37 supplies power from the counterpart elevator control panel 4 to a control circuit 38. The control circuit 13, the control circuit 26, and the control circuit 38 are connected, for example, in a ring-like form via communication wires so that information can be transmitted to the control circuit 13.

If the monitoring system 1 includes a plurality of communication circuits, the monitoring system 1 can communicate with the monitoring center even during maintenance on a monitoring device being performed. If the monitoring system 1 includes the communication circuit 14 as a main communication circuit, the monitoring system 1 may include the communication circuit 51 and include no communication circuit 54. The monitoring system 1 may include the communication circuit 54 and include no communication circuit 51. If the monitoring system 1 includes a plurality of communication circuits other than the communication circuit 14, the plurality of communication circuits may be prioritized and used in order of priority.

If the monitoring system 1 includes a plurality of monitoring devices 7, not all of the monitoring devices 7 include a communication circuit 54. Some of the monitoring devices 7 may include a communication circuit 54. For example, one monitoring device 7 alone may include a communication circuit 54.

### INDUSTRIAL APPLICABILITY

A monitoring system according to this invention is applicable to a system that can communicate with a monitoring center.

### REFERENCE SIGNS LIST

1 monitoring system, 2 elevator control panel, 3 elevator control panel, 4 elevator control panel, 5 monitoring device, 6 monitoring device, 7 monitoring device, 8 communication wire, 9 power supply wire, 10 control circuit, 11 switch, 12 power supply circuit, 13 control circuit, 14 communication circuit, 15 storage battery, 16 switch, 17 transformer, 18 diode, 19 communication wire, 20 power supply wire, 21 communication wire, 22 power supply wire, 23 control circuit, 24 switch, 25 power supply circuit, 26 control circuit, 27 storage battery, 28 switch, 29 transformer, 30 diode, 31 switch, 32 communication wire, 33 communication wire, 34 power supply wire, 35 control circuit, 36 switch, 37 power supply circuit, 38 control circuit, 39 storage battery, 40 switch, 41 transformer, 42 communication wire, 43 communication wire, 44 power supply wire, 45 UPS, 46 UPS, 47 switch, 48 UPS, 49 diode, 50 switch, 51 communication circuit, 52 communication wire, 53 power supply wire, 54 communication circuit, 55 communication wire, 56 power supply wire, 57 power supply wire, 58 power supply wire

1. A monitoring system comprising:
a first elevator control panel;
a first monitoring device capable of communicating with the first elevator control panel;
a second elevator control panel; and
a second monitoring device capable of communicating with the second elevator control panel, wherein:
the first monitoring device includes
a first communication circuit that communicates with a monitoring center,
a first control circuit that controls the first communication circuit and supplies power to the first communication circuit, and
a first power supply circuit that supplies power from the first elevator control panel to the first control circuit;
the second monitoring device includes
a second control circuit, and
a second power supply circuit that supplies power from the second elevator control panel to the second control circuit;
the first control circuit and the second control circuit are connected via a communication wire so that information can be transmitted to the first control circuit; and
if power supply from the first power supply circuit to the first control circuit fails, power from the second elevator control panel is supplied from the second power supply circuit to the first control circuit.

2. The monitoring system according to claim 1, wherein:
the first power supply circuit includes
a first transformer that transforms an AC voltage from is first elevator control panel into a DC voltage, and
a first diode including an anode connected to the first transformer and a cathode connected to the first control circuit; and
the second power supply circuit includes
a second transformer that transforms an AC voltage from the second elevator control panel into a DC voltage, and
a second diode including an anode connected to the second transformer and a cathode connected to the cathode of the first diode.

3. The monitoring system according to claim 1, wherein:
the first power supply circuit includes
a first UPS that transforms an AC voltage from the first elevator control panel into a DC voltage, and
a first diode including an anode connected to the first UPS and a cathode connected to the first control circuit; and
the second power supply circuit includes
a second UPS that transforms an AC voltage from the second elevator control panel into a DC voltage, and
a second diode including an anode connected to the second UPS and a cathode connected to the cathode of the first diode.

4. The monitoring system according to claim 1, wherein:
the second monitoring device further includes a second communication circuit that communicates with the monitoring center, and
the second control circuit controls the second communication circuit and supplies power to the second communication circuit.

5. The monitoring system according to claim 1, further comprising:
a third elevator control panel; and
a third monitoring device capable of communicating with the third elevator control panel, wherein:
the third monitoring device includes
a third control circuit, and
a third power supply circuit that supplies power from the third elevator control panel to the third control circuit; and
the first control circuit, the second control circuit, and the third control circuit are connected via communication wires so that information can be transmitted to the first control circuit.

6. The monitoring system according to claim 2 further comprising:
a third elevator control panel; and
a third monitoring device capable of communicating with the third elevator control panel, wherein:
the third monitoring device includes
a third control circuit, and
a third power supply circuit that supplies power from the third elevator control panel to the third control circuit;
the third power supply circuit includes
a third transformer that transforms an AC voltage from the third elevator control panel into a DC voltage, and
a third diode including an anode connected to the third transformer and a cathode connected to the cathode of the first diode; and
the first control circuit, the second control circuit, and the third control circuit are connected via communication wires so that information can be transmitted to the first control circuit.

7. The monitoring system according to claim 3 further comprising:
a third elevator control panel; and
a third monitoring device capable of Communicating with the third elevator control panel, wherein:
the third monitoring device includes
a third control circuit, and
a third power supply circuit that supplies power from the third elevator control panel to the third control circuit:
the third power supply circuit includes
a third UPS that transforms an AC voltage from the third elevator control panel into a DC voltage, and
a third diode including an anode connected to the third UPS and a cathode connected to the cathode of the first diode; and
the first control circuit, the second control circuit, and the third control circuit are connected via communication wires so that information can be transmitted to the first control circuit.

8. The monitoring system according to claim 5, wherein:
the third monitoring device further includes a third communication circuit that communicates with the monitoring center; and
the third control circuit controls the third communication circuit and supplies power to the third communication circuit.

9. A monitoring system comprising:
a first elevator control panel;
a first monitoring device capable of communicating with the first elevator control panel;
a second elevator control panel; and
a second monitoring device capable of communicating with the second elevator control panel, wherein:
the first monitoring device includes
a first communication circuit that communicates with a monitoring center,
a first control circuit that controls the first communication circuit and supplies power to the first communication circuit, and
a first power supply circuit that supplies power from the first elevator control panel to the first control circuit;
the second monitoring device includes
a second communication circuit that communicates with the monitoring center,
a second control circuit that controls the second communication circuit and supplies power to the second communication circuit, and
a second power supply circuit that supplies power from the second elevator control panel to the second control circuit; and
the first control circuit and the second control circuit are connected via a communication wire so that information can be transmitted to the first control circuit.

10. The monitoring system according to claim 9, wherein:
the first monitoring device further includes a first storage battery;
the first power supply circuit includes a first transformer that transforms an AC voltage from the first elevator control panel into a DC voltage;
if power supply from the first power supply circuit to the first control circuit fails, power is supplied from the first storage battery to the first control circuit;
the second monitoring device further includes a second storage battery,
the second power supply circuit includes a second transformer that transforms an AC voltage from the second elevator control panel into a DC voltage; and
if power supply from the second power supply circuit to the second control circuit fails, power is supplied from the second storage battery to the second control circuit.

11. The monitoring system according to claim 9, wherein:
the first power supply circuit include a first UPS that transforms an AC voltage from the first elevator control panel into a DC voltage; and
the second power supply circuit includes a second UPS that transforms an AC voltage from the second elevator control panel into a DC voltage.

12. The monitoring system according to claim 9, further comprising:
a third elevator control panel; and
a third monitoring device capable of communicating with the third elevator control panel, wherein:
the third monitoring device includes
a third communication circuit that communicates with the monitoring center,
a third control circuit that controls the third communication circuit and supplies power to the third communication circuit; and
a third power supply circuit that supplies power from the third elevator control panel to the third control circuit; and
the first control circuit, the second control circuit, and the third control circuit are connected via communication wires so that information can be transmitted to the first control circuit.

13. The monitoring system according to claim 12, wherein:
the third monitoring device further includes a third storage battery;
the third power supply circuit includes a third transformer that transforms an AC voltage from the third elevator control panel into a DC voltage; and
if power supply from the third power supply circuit to the third control circuit fails, power is supplied from the third storage battery to the third control circuit.

14. The monitoring system according to claim 12, wherein the third power supply circuit includes a third UPS that transforms an AC voltage from the third elevator control panel into a DC voltage.
